(19) United States
(12) Patent Application Publication
(10) Pub. No.: US 2009/0247144 A1
(43) Pub. Date: Oct. 1, 2009

(54) COMMUNICATION APPARATUS AND METHOD FOR MODIFYING SYSTEM FEATURES THEREOF

(75) Inventors: Lei Jin, Shenzhen City (CN); Kim-Yeung Sip, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD., Shenzhen City (TW); HON HAI PRECISION INDUSTRY CO., LTD., Tu-Cheng (TW)

(21) Appl. No.: 12/410,451

(22) Filed: Mar. 24, 2009

(30) Foreign Application Priority Data
Mar. 27, 2008 (CN) 200810300738.4

(51) Int. Cl. H04M 3/00; G06F 9/44

(52) U.S. Cl. 455/418; 713/100

(57) ABSTRACT

An exemplary communication apparatus includes at least one system feature. The communication apparatus includes a storage device, a motion sensor, and a controller. The storage device stores a plurality of system parameters for the at least one system feature. The motion sensor detects a movement of the communication apparatus and generates motion data in response to the movement. The controller receives the motion data and the system parameters. The controller selects a system parameter based on the motion data, and modify the at least one selected feature according to the selected parameter.

### BACKGROUND

1. Field of the Invention

The present disclosure relates to communication, and particularly to a communication apparatus and method for modifying system features of the communication apparatus.

2. Description of Related Art

Generally, communication apparatuses, such as cellular telephones, are designed to allow user's preferences. For example, a user may change ring mode to vibration mode as the need arises.

However, such system features are usually changed manually. Other features such as a “profile” may be changed/selected, however, this requires manual operation also.

Therefore, it is desired to provide a communication apparatus and method to overcome the above-described shortcomings and deficiencies.

### BRIEF DESCRIPTION OF THE DRAWINGS

FIG. 1 is a block diagram of a communication apparatus in accordance with an exemplary embodiment.

FIG. 2a is a block diagram for modifying ring setting based on movement in accordance with an exemplary embodiment.

FIG. 2b is a block diagram for modifying ring setting in combination with wallpaper based on motion movement in accordance with another exemplary embodiment.

FIG. 3 is a flow chart illustrating a method for modifying system features of the communication apparatus in FIG. 1 in accordance with an exemplary embodiment.

FIG. 4 is a flow chart illustrating a method for modifying system features of the communication apparatus in FIG. 1 in accordance with another exemplary embodiment.

### DETAILED DESCRIPTION

In general, the present disclosure provides a communication apparatus having a novel and unobvious feature of modifying a system feature such as a ring setting based on a predetermined movement detected by a motion sensor of the communication apparatus. It should be noted that the present disclosure is not directed to invoke an application of the communication apparatus, such as unlocking the communication apparatus when a predetermined style of movement is detected by the motion sensor. But rather, the present disclosure is directed to change system parameters/settings of the system feature based on predetermined movement detected by the motion sensor of the communication apparatus. With this feature, various system features of the communication apparatus can be modified only by manipulating the communication apparatus without using an input device of the communication device.

In one aspect, the system features can be modified based on a predetermined configuration using a template. The template may include a plurality of motion data indicating the movement and a plurality of system parameters. Each of the motion data is associated with a system parameter of the system feature correspondingly.

In another aspect, the system features can be modified by randomly selecting a system parameter for a system feature when a particular movement of the communication apparatus is detected. It is noted that randomly selecting the system parameter may have the benefits of keeping the attention of a user of the communication apparatus as “fresh.” More details with respect to the above-described features will be described hereafter.

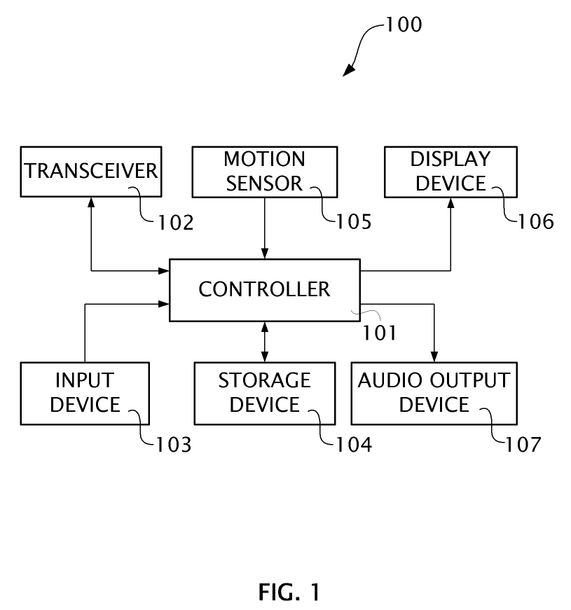

Referring to FIG. 1, a communication apparatus 100 in accordance with an exemplary embodiment includes a controller 101, a transceiver 102, an input device 103, a storage device 104, a motion sensor 105, a display device 106, and an audio output device 107.

The controller 101 is configured to communicate with various components of the communication apparatus 100, and is configured to control operations of the communication apparatus 100.

The transceiver 102 is configured to communicate with a base station (not shown) to allow the communication apparatus 100 to receive a call or send a short message.

The input device 103 may be a keypad, which is designed to allow a user to input commands to the communication apparatus 100.

The motion sensor 105 may be an accelerometer or an orientation sensor. The motion sensor 105 is configured to detect a movement of the communication apparatus 100, and generate motion data indicating the movement correspondingly.

The display device 106 may be a liquid crystal display (LCD), which is configured to display video or graphical data, such as a wallpaper of the communication apparatus 100. The audio output device 107 may be a speaker, which is configured to output audible sounds such as a predetermined ringtone to indicate an incoming call.

The storage device 104 may store system software to be executed by the controller 101 and user data such as phone book and call history.

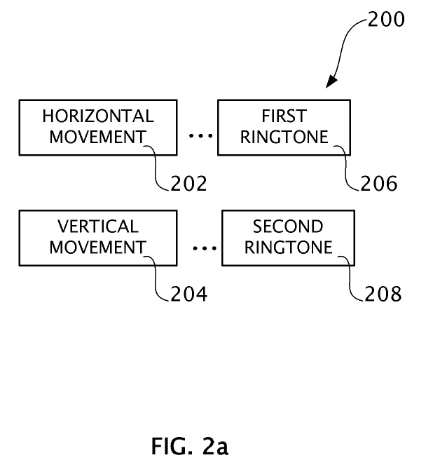

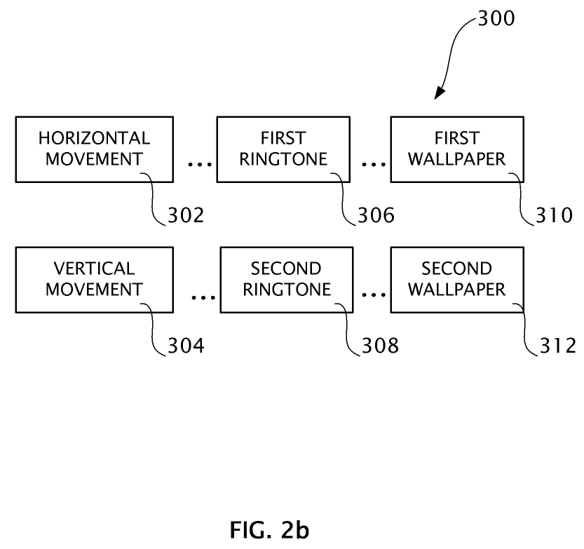

In particular, referring to FIG. 2a and FIG. 2b the storage device 104 further stores motion templates 200 or 300. The motion templates 200 or 300 may be pre-configured manually or downloaded from another communication apparatus or from a network.

Generally, the motion templates 200 or 300 includes various motion data associated with a plurality of system parameters of at least one system feature. In one embodiment, referring to FIG. 2a, the motion template 200 is configured to associate the motion data with one system feature such as a ring setting of the communication apparatus 100. For example, a horizontal movement 202 is associated with a first ringtone 206. A vertical movement 204 is associated with a second ringtone 208. When the horizontal movement 202 is detected by the motion sensor 105, the ring setting of the communication apparatus 100 is automatically changed to the first ringtone 206. When the vertical movement 204 is detected by the motion sensor 105, the communication apparatus 100 is automatically modified to alert the user with the second ringtone 208.

In another embodiment, referring to FIG. 2b, the motion template 300 is configured to associate the motion data with two system features of the communication apparatus 100. The two system features can be defined as a “profile”. The profile may include a ring setting in combination with a wallpaper. For example, a horizontal movement 302 is associated with a first ringtone 306 and a first wallpaper 310. A vertical movement 304 is associated with a second ringtone 308 and a second wallpaper 312. In this case, when the horizontal movement 302 is detected by the motion sensor 105, the communication apparatus 100 is automatically modified to alert the user with the first ringtone 306 and display the first wallpaper 310. When the vertical movement 304 is detected by the motion sensor 105, the communication apparatus 100 is automatically modified to alert the user with the second ringtone 308 and display the second wallpaper 312.

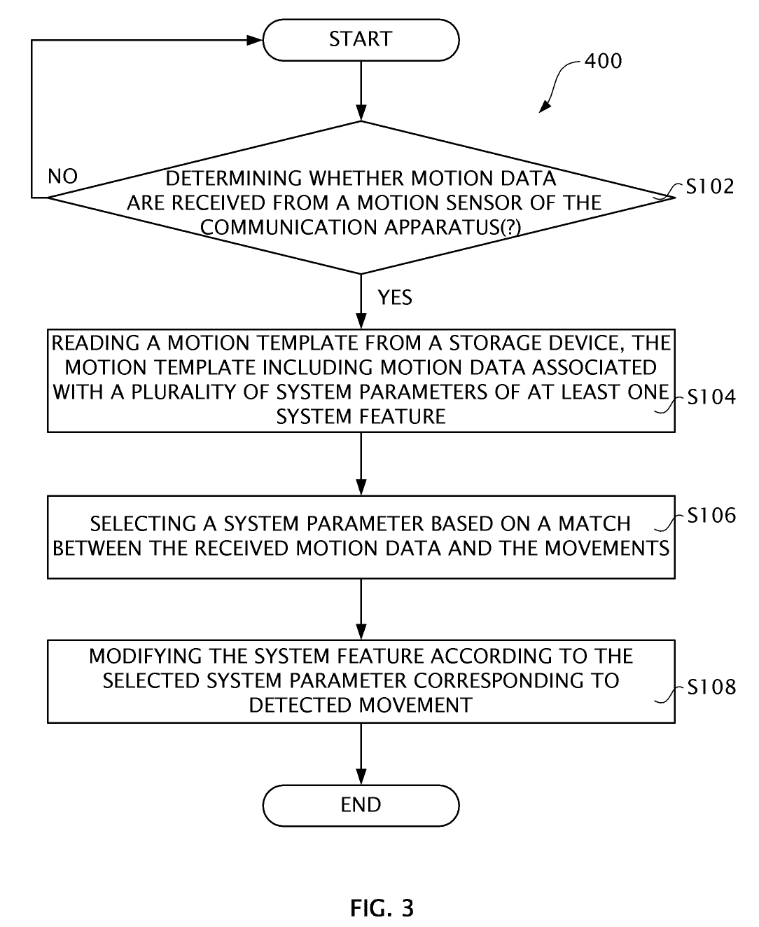

Referring to FIG. 3, in an exemplary embodiment, a flowchart illustrating various actions of a method 400 for modifying system features of the communication apparatus 100 is shown.

At block S102, the controller 101 determines whether motion data are received from the motion sensor 105 of the communication apparatus 100. The motion data indicate corresponding movement of the communication apparatus 100. If yes, the procedure goes to block S104. If no, the procedure goes to start.

At block S104, the controller 101 reads motion templates 200 or 300 from the storage device 104. The motion templates 200 or 300 includes various motion data associated with a plurality of system parameters of at least one system feature.

At block S106, the controller 101 selects system parameters from the motion templates 200 or 300 based on a match between the received motion data and the movements. For example, in one embodiment, the controller 101 selects the first ringtone 206 when the horizontal movement 202 is detected by the motion sensor 105. In another embodiment, the controller 101 selects both the first ringtone 306 and the first wallpaper 310 when the horizontal movement 302 is detected by the motion sensor 105.

At block S108, the controller 101 modifies a system feature of the communication apparatus 100 according to the selected system parameters.

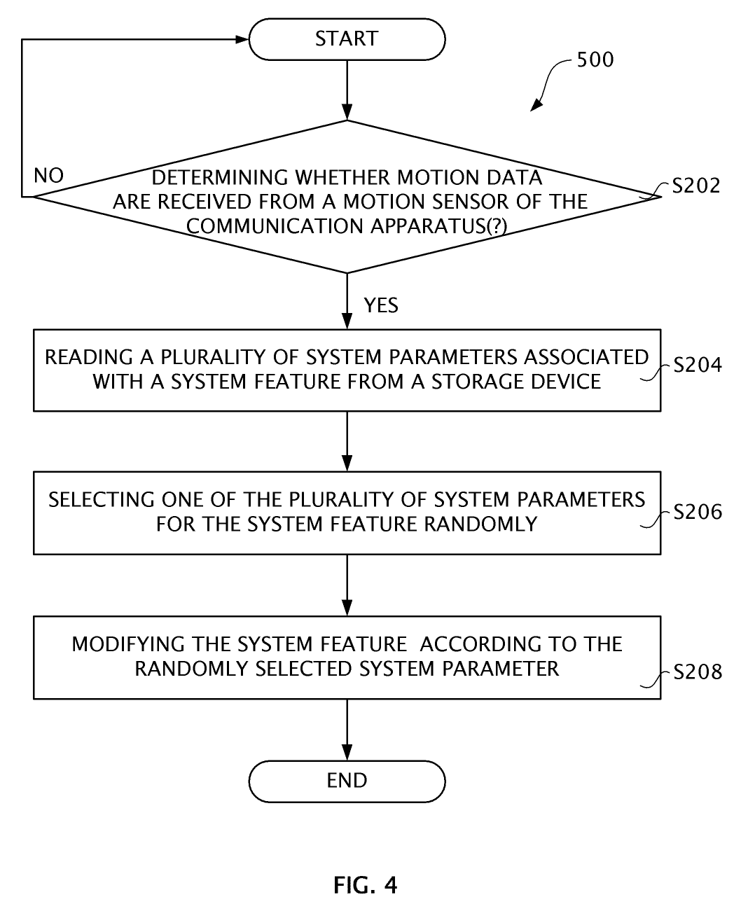

Referring to FIG. 4, in another exemplary embodiment, a flowchart illustrates various actions of a method 500 for modifying system features of the communication apparatus 100 is shown.

At block S202, the controller 101 determines whether motion data are received from the motion sensor 105 of the communication apparatus 100. The motion data indicate corresponding movement of the communication apparatus 100. If yes, the procedure goes to block S204. If no, the procedure goes to start.

At block S204, the controller 101 reads a plurality of system parameters associated with a system feature of the communication apparatus 100 from the storage device 104.

At block S206, the controller 101 randomly selects one system parameter from the plurality of system parameters for the system feature.

At block S208, the controller 101 modifies the system feature of the communication apparatus 100 according to the randomly selected system parameters.

As described above, a system feature such as a ring setting can be modified based on particular movement detected by the motion sensor of the communication apparatus. By such a configuration, the system feature can be modified in response to a movement of the communication apparatus without using an input device of the communication device.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A communication apparatus having at least one system feature, the communication apparatus comprising:
a storage device configured to store a plurality of system parameters for the at least one system feature;
a motion sensor configured to detect a movement of the communication apparatus and generate motion data in response to the movement; and
a controller configured to receive the motion data transmitted from the motion sensor and the system parameters transmitted from the storage device, the controller further configured to select a system parameter based on the motion data, and modify the selected at least one system feature according to the selected parameter.

2. The communication apparatus according to claim 1, wherein the system parameter for the selected at least one system feature to be modified is randomly selected from the storage device.

3. The communication apparatus according to claim 1, further comprising an input device, the input device being configured to preset the plurality of parameters for each feature of the at least one system features to be associated with a plurality of motions of the communication device.

4. The communication apparatus according to claim 3, wherein the storage device is further configured to store a motion template, and the motion template includes system parameters of one system feature preset to the corresponding motion data.

5. The communication apparatus according to claim 3, wherein the storage device is further configured to store a motion template, and the motion template includes system parameters of two system features preset to the corresponding motion data respectively.

6. The communication apparatus according to claim 1, wherein the at least one system feature is a ring setting for alerting purpose.

7. The communication apparatus according to claim 1, wherein the at least one system feature is a wallpaper.

8. A method for modifying at least one system feature of a communication apparatus, the method comprising:
determining whether motion data are received from a motion sensor of the communication apparatus, the motion data indicating a movement of the communication apparatus;
reading a motion template from a storage device of the communication apparatus upon determination that the motion data are received from the motion sensor, the motion template specifying a plurality of movement data associated with a plurality of system parameters of the at least one system feature;
selecting system parameters for the at least one system feature based on a match between the received motion data indicating the movement and the motion template; and
modifying the at least one system feature according to the selected system parameters.

9. The method according to claim 8, wherein the action of modifying the at least one system feature according to the selected system parameter comprises:
modifying a ring setting of the communication apparatus according to the selected system parameters.

10. The method according to claim 9, wherein the action of modifying a ring setting of the communication apparatus according to the selected system parameters comprises:
modifying the ring setting with a first ringtone when a horizontal movement is detected by the motion sensor of the communication apparatus; and
modifying the ring setting with a second ringtone when a vertical movement is detected by the motion sensor of the communication apparatus.

11. The method according to claim 8, wherein the action of modifying the at least one system feature according to the selected system parameter comprises:
modifying a ring setting in combination with a wallpaper of the communication apparatus according to the selected system parameters.

12. The method according to claim 1, wherein the action of modifying a ring setting in combination with a wallpaper of the communication apparatus according to the selected system parameters comprises:
modifying the ring setting with a first ringtone and a first wallpaper when a horizontal movement is detected by the motion sensor of the communication apparatus; and
modifying the ring setting with a second ringtone and a second wallpaper when a vertical movement is detected by the motion sensor of the communication apparatus.

13. A method for modifying at least one system feature of a communication apparatus, the method comprising:
determining whether motion data are received from a motion sensor of the communication apparatus, the motion data indicating a movement of the communication apparatus;
reading a plurality of system parameters for the at least one system feature from a storage device of the communication apparatus upon determination that the motion data are received from the motion sensor;
randomly selecting system parameters for the at least one system feature based on the received motion data; and
modifying the at least one system feature of the communication apparatus according to the selected system parameters.

14. The method according to claim 13, wherein the action of modifying the at least one system feature according to the selected system parameters comprises:
modifying a ring setting of the communication apparatus according to the selected system parameters.

15. The method according to claim 14, wherein the action of modifying a ring setting of the communication apparatus according to the selected system parameters comprises:
modifying the ring setting with a first ringtone when a horizontal movement is detected by the motion sensor of the communication apparatus; and
modifying the ring setting with a second ringtone when a vertical movement is detected by the motion sensor of the communication apparatus.

16. The method according to claim 13, wherein the action of modifying the at least one system feature according to the selected system parameters comprises:
modifying a ring setting in combination with a wallpaper of the communication apparatus according to the selected system parameters.

17. The method according to claim 16, wherein the action of modifying a ring setting in combination with a wallpaper of the communication apparatus according to the selected system parameters comprises:
modifying the ring setting with a first ringtone and a first wallpaper when a horizontal movement is detected by the motion sensor of the communication apparatus; and
modifying the ring setting with a second ringtone and a second wallpaper when a vertical movement is detected by the motion sensor of the communication apparatus.
